(19) United States
(12) Patent Application Publication
(10) Pub. No.: US 2013/0050829 A1
(43) Pub. Date: Feb. 28, 2013

(54) BEAMSPLITTER AND METHOD OF BEAMSPLITTING

(71) Applicant: Oleg M. Efimov, Thousand Oaks, CA (US)

(72) Inventor: Oleg M. Efimov, Thousand Oaks, CA (US)

(73) Assignee: HRL LABORATORIES, LLC, Malibu, CA (US)

(21) Appl. No.: 12/816,355

(22) Filed: Jun. 15, 2010

(51) Int. Cl. G02B 27/44

(52) U.S. Cl. 359/569

(57) ABSTRACT

A beamsplitter for splitting the light of an incident beam into four separate beams. The beamsplitter includes a pair of gratings each disposed preferably normal to the incident beam and having grating vectors preferably orthogonal to one another. The pair of gratings may be formed on opposite sides of a common substrate. A method of splitting an incident, collimated beam of light of a given wavelength into four separate collimated beams each disposed at angles of elevation θ_{d} from an axis of the collimated beam of light and of azimuth φ_{d} in a plane orthogonal to the axis of the collimated beam of light.

### CROSS REFERENCE TO RELATED APPLICATIONS

None

### TECHNICAL FIELD

This disclosure relates to a beamsplitter that consists of two diffractive gratings used to split one collimated beam in four identical beams (i.e. a 1-to-4 beamsplitter) symmetrically distributed in the space relative to the axis of incident beam.

### BACKGROUND

The simplest and direct way to split a beam into four beams is to split the beam initially into two beams, and then split each of two beams into two further beams one more time using standard beamsplitters like partially reflected mirrors, cubes, etc., and then combine all four beams, as needed, in a required configuration. However, in case of large-area beams, this technique will result in an extremely cumbersome setup.

Another technique for making a 1-to-4 beamsplitter is to create a special diffractive optical element which is basically a grating with some complicated shape that generates the desired distribution of beams (see e.g., M. A. Golub, “Laser beam splitting by diffractive optics,” Optics and Photonics News, February 2004, pp. 37-41, the disclosure of which is hereby incorporated herein by reference). However, to fabricate such a complicated shape, e-beam lithography should be applied in most cases. This results in a rather long time to make the device and at a rather substantial cost.

Another design possibly appropriate for 1-to-4 beamsplitter has apparently been developed by Ibsen Photonics A/S. See www.ibsen.dk/products/phasemasks/2dphasemasks.

### BRIEF DESCRIPTION OF THE INVENTION

A one-to-four beamsplitter for splitting the light of an incident beam into four separate beams, the beamsplitter comprising: a pair of gratings each disposed preferably normal to the incident beam and preferably orthogonal to one another.

A method of splitting an incident, collimated beam of light of a given wavelength into four separate collimated beams each disposed at angles of elevation θ_{d} and of azimuth φ_{d}, the angles of elevation θ_{d} ranging between 0 and π radians from an axis of the collimated beam of light and the angles of azimuth φ_{d} each equal to ±π/4 radians and ±3π/4 radians in a plane orthogonal to the axis of the collimated beam of light for gratings with orthogonal grating vectors. If the two gratings are not orthogonal to each other, four beams of light are obtained, but not necessarily symmetric or at elevations and azimuths a multiple of π/4 radians. The method includes disposing a first diffraction grating in a grating vector orientation normal to the collimated beam of light, the first diffraction grating having a period equal to two times the given wavelength; and disposing a second diffraction grating in a grating vector orientation normal to both the collimated beam of light and the first diffraction grating vector, the second diffraction grating having a period equal to two times the given wavelength.

### BRIEF DESCRIPTION OF THE DRAWINGS

FIG. 1 depicts the optical scheme of 1-to-4 beamsplitter disclosed herein.

FIG. 2 depicts a technique for the calculation of diffracted beam direction.

FIGS. 3a and 3b depict grating groove orientations for (a) the first (element 2 in FIG. 1) and (b) second (element 6 in FIG. 1) square gratings, respectively.

FIG. 4 shows the gratings etched or otherwise formed on a common substrate.

FIG. 5 depicts a more generalized technique for the calculation of diffracted beam direction.

### DETAILED DESCRIPTION

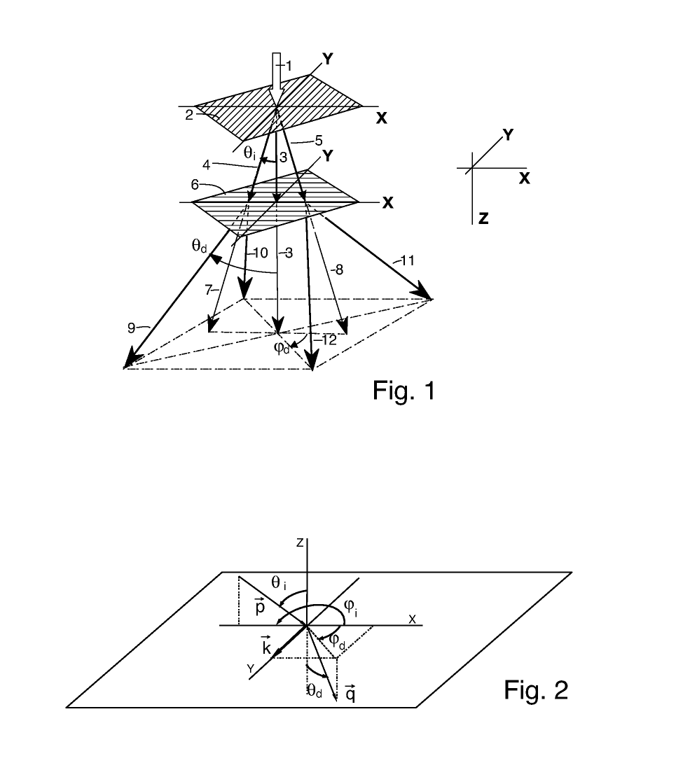

The optical scheme of the 1-to-4 beamsplitter is shown in FIG. 1. In this figure, a collimated incident optical beam 1, on an axis parallel to the depicted Z axis, passes a first diffraction grating 2 at a normal angle of incidence thereto and splits into three beams: (a) a zero order beam 3 on the Z axis and (b) two identical first order diffracted beams 4 and 5. The a first diffraction grating 2 has a major surface disposed preferably parallel to the XY plane shown in this figure and thus is orientated preferably normal to the Z axis. The angle θᵢ of beam diffractions depends on grating period Λ₁ and beam wavelength λ and can be found from the following known formula:

sin θᵢ=λ/Λ₁ (Eqn. 1)

It is well known in the art (e.g., M. A. Golub. “Laser beam splitting by diffractive optics,” Optics and Photonics News, February 2004, p. 37-41) that intensity of the zero order beam 3 can be suppressed down to a few percent by means of a rectangular groove profile of the grating of the first diffraction grating 2. This maximizes the intensities of the two first order beams 4 and 5 which then pass a second diffraction grating 6 with grooves arranged orthogonally to the grooves of first diffraction grating 2. The a second diffraction grating 6 has a major surface which is also disposed parallel to the XY plane shown in this FIG. 1. The zero order beams are not used and therefor it is preferable that they be suppressed as far as reasonably possible to maximize the intensities of the various diffracted optical beams 4 and 5 (from grating 2) and 9-12 (from grating 6).

The zero order beam 3 will also split when passing the grooves of the second diffraction grating 6, but those split beams are not depicted for clarity of illustration, especially since the zero order beam is preferably largely suppressed in the first place by the first diffraction grating 2 (and also by the second diffraction grating 6 for that mater). The zero order beam 3 is depicted since it is on the Z axis which is used to define the angles of elevation θᵢ and θ_{d} for the split beams from 4 and 5 the first diffraction grating 2 and the split beams 9, 10, 11 and 12 from the second diffraction grating 6.

The two zero order beams 7 and 8 produced by the second diffraction grating 6 are also preferably suppressed down to a few percent using the rectangular groove profile technique discussed above thereby maximizing the first order beams 9, 10, 11 and 12 produced by the second diffraction grating 6. Other groove profiles, than the rectangular groove profile technique discussed above, are possible, but they result in a higher magnitude of the transmitted beam normal to the grating and less energy in the split beams. Hence the rectangular groove profile technique discussed above is preferred. The other potential groove profiles include triangular, sinusoidal, semi-circular, rectangular other shapes. The grooves are equally spaced.

The dependence of the angles of elevation θ_{d} and of azimuth φ_{d} of beams diffracted by grating with a period Λ₂ can be found from the known formulas:

$$\begin{matrix} \vec{k} = {\vec{e}}_{x} {k}_{x} + {\vec{e}}_{y} {k}_{y} ; \\ \vec{p} = {\vec{e}}_{x} {p}_{x} + {\vec{e}}_{y} {p}_{y} - {\vec{e}}_{z} \sqrt{{\vec{p}}^{2} - {p}_{x}^{2} - {p}_{y}^{2}} ; \\ \vec{q} = {\vec{e}}_{x} ( {p}_{x} \pm {mk}_{x} ) \pm {\vec{e}}_{y} ( {p}_{y} \pm {mk}_{y} ) + {\vec{e}}_{z} \sqrt{\begin{matrix}{\vec{q}}^{2} - {( {p}_{x} \pm {mk}_{x} )}^{2} - \\ {( {p}_{y} \pm {mk}_{y} )}^{2}\end{matrix}} ; \\ \vert \vec{k} \vert = \frac{2 π}{{Λ}_{2}} ; \vert \vec{p} \vert = \vert \vec{q} \vert = \frac{2 π}{λ} ;\end{matrix} \} \qquad ( Eqn . 2 )$$

Here, \vec{k} is a grating vector with components kₓ and k_{y}, \vec{p} is an incident plane wave with components pₓ, p_{y}, and

$${p}_{z} = \sqrt{{\vec{p}}^{2} - {p}_{x}^{2} - {p}_{y}^{2}} ,$$

\vec{q} is one of diffracted plane wave, and \vec{e}ₓ, \vec{e}_{y} and \vec{e}_{z} are the unit vectors. In this case shown in FIG. 2, the incident wave \vec{p} propagates in the plane XZ and the grating vector \vec{k} is directed along the Y-axis. Then,

$$\begin{matrix} {k}_{x} = 0 \\ {p}_{y} = 0 \\ \begin{matrix} {q}_{x} = {p}_{x} = \frac{2 π}{λ} sin {θ}_{i} \\ {q}_{y} = {k}_{y} = \frac{2 π}{{Λ}_{2}} \\ {q}_{z} = \sqrt{{\vec{q}}^{2} - {q}_{x}^{2} - {q}_{y}^{2}} = \begin{matrix}\sqrt{{\vec{p}}^{2} = {p}_{x}^{2} - {k}_{y}^{2}} = \\ \frac{2 π}{λ} \sqrt{1 - {sin}^{2} {{θ}_{i} ( \frac{λ}{{Λ}_{2}} )}^{2}}\end{matrix} \\ tan {ϕ}_{d} = \frac{{q}_{y}}{{q}_{x}} = \frac{{k}_{y}}{{p}_{x}} = \frac{λ}{{Λ}_{2} sin {θ}_{i}} \\ sin {θ}_{d} = \sqrt{\frac{{q}_{x}^{2} + {q}_{y}^{2}}{{q}^{2}}} = \sqrt{\frac{{p}_{x}^{2} + {k}_{y}^{2}}{{p}^{2}}} = \sqrt{{( \frac{λ}{{Λ}_{2}} )}^{2} + {sin}^{2} {θ}_{i}}\end{matrix} \} or & ( Eqn . 3 ) \\ \begin{matrix} sin {θ}_{i} = \frac{λ}{{Λ}_{2} tan {ϕ}_{d}} \\ {sin}^{2} {θ}_{d} = {( \frac{λ}{{Λ}_{2}} )}^{2} + {sin}^{2} {θ}_{i} = \begin{matrix}{( \frac{λ}{{Λ}_{2}} )}^{2} \\ ( 1 + \frac{1}{{tan}^{2} {ϕ}_{d}} )\end{matrix} = {( \frac{λ}{{Λ}_{2} sin {ϕ}_{d}} )}^{2} \\ {Λ}_{2} = \frac{λ}{sin {θ}_{d} sin {ϕ}_{d}}\end{matrix} \} & ( Eqn 4 )\end{matrix}$$

A grating vector is a vector with a value of 2π/Λ and an orientation normal to the grating grooves in the plane of grating. This is a vector characteristic of grating while the period of grating is a scalar characteristic. The grating vector is independent on light direction or on presence of the other gratings.

In Eqn. 3, setting kₓ and p_{y} to zero corresponds to the two gratings 2, 6 being arranged with their gratings being disposed orthogonal to one anther and orthogonal to the incident beam 1. So long as the gratings, when manufactured with reasonable construction tolerances, are disposed substantially orthogonal to one anther and substantially orthogonal to the incident beam 1, the formulas of Eqn 3 and/or Eqn. 4 should suffice. However, it is possible to arrange the gratings 2, 6 such that directions of gratings are intentionally disposed at some angle other than 90 degrees to one another, then the beams which emerge will likely not be symmetrical relative to the incident beam 1 and the more complex equations of Eqn. 2 should be utilized.

The following angles of split beams are obtained for an incident optical beam 1 at a 365 nm wavelength: θ_{d}=π/4 and φ_{d}=π/4.

$$\begin{matrix} {Λ}_{2} = \frac{λ}{\frac{1}{\sqrt{2}} \frac{1}{\sqrt{2}}} = 2 λ = 730 nm \\ sin {θ}_{i} = \frac{λ}{{Λ}_{2}} = 0.5 \\ {θ}_{i} = π / 6\end{matrix} \} \qquad ( Eqn . 5 )$$

Knowing the value of the angle θᵢ, the period of the first grating (grating 2 in the figures) can be found from the equation 1 (Eqn. 1) above (the subscript 1 denotes that the calculation is for the first grating):

Λ₁=λ/sin θᵢ=2λ=730 nm. (Eqn. 6)

The grating period of grating 6 determined from the last equation of equation 4 (Eqn. 4—last equation) for Λ₂ and, for this case, from the first equation of equation 5 (Eqn. 5—first equation)—the subscript 2 denotes that the calculation is for the second grating (diffraction grating 6 in the figures). So for the case where the angles of elevation θ_{d} are equal to π/4 and the angles of azimuth (pa of the split beams 9-12 are equal +3π/4, −3π/4, −π/4, and +λ/4 radians, respectively, then the periods of the two gratings are identical to each other and each are equal to twice the wavelength of the incident beam 1. So when the incident beam has a wavelength of 365 nm, the period of diffraction gratings 2 and 6 should then each be 730 nm to achieve the four split beams 9-12 each disposed at a common angle from the axis of the incident beam 1. And more generally, when the incident beam has a given wavelength then the periods of the diffraction gratings 2 and 6 should then each be equal to twice the given wavelength in order to create the four split beams 9-12 each being disposed at a common angle from the axis of the incident beam 1.

When the periods of the gratings 2 and 6 are different from each other, then the beams 9-12 each emerge at plus or minus an angle of azimuth φ_{d} and at an angle of elevation θ_{d} where the absolute values of θ_{d} and φ_{d} are different from one another. It is easily can be found from (Eqn. 4) that

$$\begin{matrix} tan {ϕ}_{d} = \frac{{Λ}_{1}}{{Λ}_{2}} \\ {sin}^{2} {θ}_{d} = {( \frac{λ}{{Λ}_{1}} )}^{2} + {( \frac{λ}{{Λ}_{2}} )}^{2}\end{matrix} \} \qquad ( Eqn . 7 )$$

Therefore, if the periods of the gratings 2 and 6 are the same, then the beams 9-12 each emerge at plus or minus π/4 radians in azimuth and |a sin(\sqrt{2}λ/Λ)| radians in elevation where Λ=Λ₁=Λ₂.

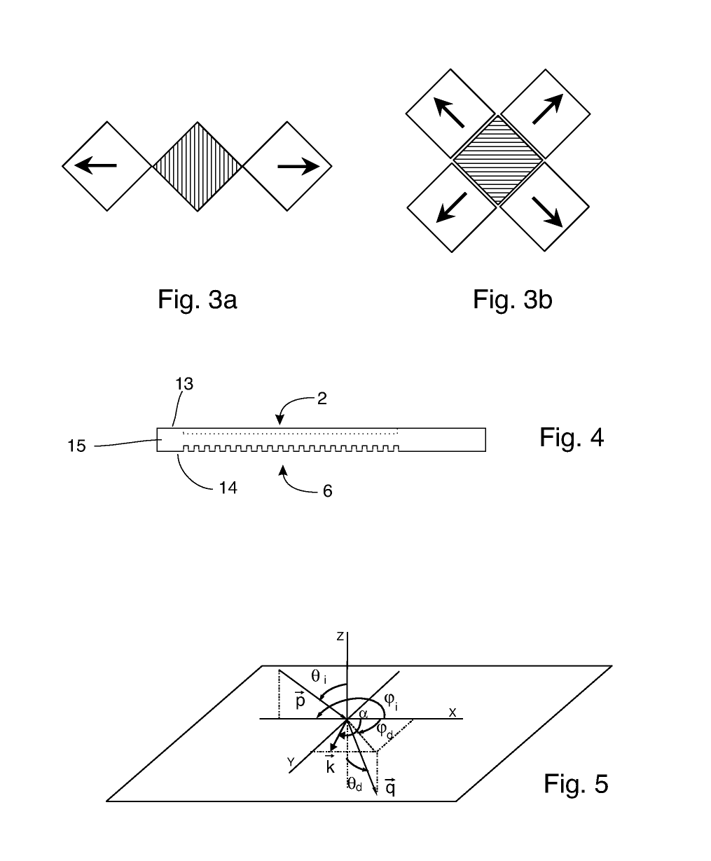

The groove patterns for gratings 2 and 6 desired for the proper splitting of the incident beam 1 into four diffracted beams 9-12 are shown in FIG. 3a (for grating 2) and FIG. 3b, (for grating 6) respectively and in FIG. 4 for when both gratings 2 and 6 are formed in a common substrate 15. The depicted patterns and shapes of gratings provide required directions of square diffracted beams. The arrows indicate the directions of diffracted beams (in the white squares) after passing the first diffraction grating 2 (FIG. 3a) and then the second diffraction grating 6 (FIG. 3b). The boxes enclosing the arrows in depict the spatial shape of diffracted beams and the directions of diffraction beams from a top down orientation along the Z axis.

This beamsplitter develops four identical collimated beams 9-12 from an incident collimated beam 1, which emerge from the same area (from grating 6) and are symmetrically (and uniformly if the gratings share a common grating period) distributed in the space relative to the axis of incident beam 1 (which is preferably arranged to be parallel to Z axis of FIG. 1).

The first and second diffraction gratings 2, 6 appear as separate gratings in FIG. 1, which they indeed are. But while their planes are disposed parallel to each other, they do not need to be necessarily disposed on separate substrates. So the first diffraction grating 2 may be disposed on or in an upper surface 13 of a substrate 15 while the second diffraction grating 6 can be disposed on or in a lower surface 14 of the same substrate 15 as shown by FIG. 4. The substrate 15 should have, of course, parallel major surfaces 13 and 14 exhibit a uniform distribution of absorption properties and a uniform refractive index. The spacings of the gratings on each surface 13 and 14 as well as the depths of the grooves on each surface 13 and 14 are preferably uniform for a given surface, but not necessarily the same for both surfaces 13 and 14.

The incident light 1 should arrive at the grating shown in FIG. 4 normal to surfaces 13, 14. In practice, since the spacings of the gratings on surfaces 13 and 14 as well as the depths of the grooves on surfaces 13 and 14 need not necessarily be identical, the correct surface for diffraction grating 2 should, of course, be arranged to receive the incident beam 1.

A More Generalized Analysis

When generating Eqn. 3 above, an assumption was made that the two grating vectors are disposed orthogonal to one another. And for most people practicing the present invention, it is believed that that assumption will hold true for them as well. But, there may be instances when that assumption is not appropriate and therefore the following more generalized analysis is presented for use in such situations allowing the grating vectors to be located non-orthogonally.

In the following analysis, the angle between the grating vector is taken to be α (see FIG. 5 where angle α to the vector \vec{k} is depicted) and one can find the angles of the diffracted beams from Eqn. 2 above:

$$\begin{matrix} {k}_{x} = \frac{2 π}{{Λ}_{2}} cos α \\ {k}_{y} = \frac{2 π}{{Λ}_{2}} sin α \\ {p}_{x} = \frac{2 π}{λ} sin {θ}_{i} \\ {p}_{y} = 0 \\ {q}_{x} = {k}_{x} + {p}_{s} = \frac{2 π}{{Λ}_{2}} cos α + \frac{2 π}{λ} sin {θ}_{i} \\ {q}_{y} = {k}_{y} + {p}_{y} = \frac{2 π}{{Λ}_{2}} sin α \\ {q}_{z} = \sqrt{{\vec{q}}^{2} - {q}_{x}^{2} - {q}_{z}^{2}} = \frac{2 π}{λ} \sqrt{\begin{matrix}1 - {( \frac{λ}{{Λ}_{2}} cos α + sin {θ}_{i} )}^{2} - \\ {( \frac{λ}{{Λ}_{2}} sin α )}^{2}\end{matrix}} \\ tan {ϕ}_{d} = \frac{{q}_{y}}{{q}_{x}} = \frac{\frac{2 π}{{Λ}_{2}} sin α}{\frac{2 π}{{Λ}_{2}} cos α + \frac{2 π}{λ} sin {θ}_{i}} \\ sin {θ}_{d} = \sqrt{\frac{{q}_{x}^{2} + {q}_{y}^{2}}{{q}^{2}}} = \sqrt{\frac{{( \begin{matrix}\frac{2 π}{{Λ}_{2}} cos α + \\ \frac{2 π}{λ} sin {θ}_{i}\end{matrix} )}^{2} - {( \frac{2 π}{{Λ}_{2}} sin α )}^{2}}{{( \frac{2 π}{λ} )}^{2}}}\end{matrix} \} \qquad ( Eqn . 8 )$$

and simplifying two last equations of Eqn. 8:

$$\begin{matrix} tan {ϕ}_{d} = \frac{λ sin α}{λ cos α + {Λ}_{2} sin {θ}_{i}} \\ sin {θ}_{d} = \sqrt{{( \frac{λ}{{Λ}_{2}} cos α + sin {θ}_{i} )}^{2} + {( \frac{λ}{{Λ}_{2}} sin α )}^{2}}\end{matrix} \} \qquad ( Eqn . 9 )$$

When the angle between the grating vectors is equal 90° (means that sin α=1 and cos α=0), the equations of Eqn. 9 reduce to Eqn. 3 above.

Having described the invention in connection with a preferred embodiment thereof, modification will now suggest itself to those skilled in the art. For example, the present disclosure teaches how split a single incident collimated beam into four collimated beams symmetrically distributed in the space relative to the axis of incident collimated beam using two diffraction gratings. Additional splits could be accomplished by using additional diffraction gratings disposed in parallel to the first two diffraction gratings. As such, the invention is not to be limited to the disclosed embodiments except as is specifically required by the appended claims.

1. A one-to-four beamsplitter for splitting the light of an incident beam of light into exactly four separate maximal intensity light beams, the beamsplitter comprising: a pair of gratings each disposed substantially normal to the incident beam, the pair of gratings each having grating lines which are disposed substantially orthogonal to one another, the exactly four separate maximal intensity light beams emanating, in use, from said one of said pair of gratings.

2. The one-to-four beamsplitter of claim 1 wherein said pair of gratings each occupy a major plane which are disposed parallel to one another and wherein said pair of gratings are disposed on or in a common substrate.

3. The one-to-four beamsplitter of claim 2 wherein the four separate beams emerge, in use, from a common one of said pair of gratings.

4. The one-to-four beamsplitter of claim 3 wherein the four separate beams each comprise a first order beam and wherein the pair of gratings each include means to suppress zero order beams.

5. The one-to-four beamsplitter of claim 3 wherein the grating lines, in profile, have a rectangular configuration for suppressing zero order beams.

6. The one-to-four beamsplitter of claim 3 wherein the pair of gratings have a common grating period whereby the four separate beams emerge, in use, at a uniform angle from an axis normal to both of the pair of gratings.

7. (canceled)

8. A method of splitting an incident, collimated beam of light of a given wavelength into four separate collimated beams each disposed at angles of elevation θ_{d} equal to π/4 radians and of azimuth φ_{d} equal to +π/4 radians, −π/4 radians, +3π/4 radians, and −3π/4 radians from a axis of the collimated beam of light, the method comprising:
disposing a first diffraction grating in a grating vector orientation normal to said collimated beam of light, the first diffraction grating having a period equal to two times said given wavelength; and
disposing a second diffraction grating in a grating vector orientation normal to both said collimated beam of light and said first diffraction grating vector, the second diffraction grating having a period equal to two times said given wavelength.

9. The method according to claim 8 wherein including disposing the first and second diffraction gratings on a common substrate.

10. A one-to-four beamsplitter for splitting the light of an incident normal beam of light into exactly four separate maximal intensity light beams, the beamsplitter comprising: a pair of gratings each having grating lines and a major plane which is disposed parallel to one another, and the pair of grating being disposed at a first predetermined angle to the incident beam and being disposed with their grating lines having orientations at a second predetermined angle relative to one another, the exactly four separate maximal intensity light beams emanating, in use, from said one of said pair of gratings.

11. The one-to-four beamsplitter of claim 10 wherein the first predetermined angle equals ninety degrees.

12. The one-to-four beamsplitter of claim 11 wherein the second predetermined angle equals ninety degrees.

13. The one-to-four beamsplitter of claim 12 wherein said pair of gratings are disposed on or in a common substrate.

14. The one-to-four beamsplitter of claim 13 wherein first order beams emerge, in use, from said beamsplitter and wherein the pair of gratings each include means to suppress zero order beams.

15. The one-to-four beamsplitter of claim 14 wherein the pair of gratings have a common grating period whereby the first order beams emerge, in use, at a uniform angle from an axis normal to both of the pair of gratings.

16. The one-to-four beamsplitter of claim 13 wherein the gratings, in profile, have a rectangular configuration.
